(19) United States
(12) Patent Application Publication
(10) Pub. No.: US 2026/0295683 A1
(43) Pub. Date: Oct. 1, 2026

(54) BAR CONTACT IMPROVEMENT

(71) Applicant: Gurinder Singh, Longmont, CO (US)

(72) Inventor: Gurinder Singh, Longmont, CO (US)

(21) Appl. No.: 19/089,054

(22) Filed: Mar. 25, 2025

(51) Int. Cl. B23B 31/20

(52) U.S. Cl. CPC B23B 31/20

(57) ABSTRACT

A sleeve includes an outer surface having a length between first and second ends and, defined by an inner surface having a length between the first and second ends, an internal chamber having a longitudinal centerline. The inner surface includes two or more regions having a first perpendicular distance from the longitudinal centerline separated by two or more regions having a second perpendicular distance from the longitudinal centerline that is different from the first perpendicular distance. A bushing for coupling a tool to a tool holder includes an outer surface having a length between first and second ends and, defined by an inner surface having a length between the first and second ends, an internal chamber having a longitudinal centerline. The inner surface includes two or more contact patches separated by a rotation about the longitudinal centerline.

### SUMMARY

The disclosure describes a first sleeve for coupling a tool to a tool holder. The sleeve includes an outer surface having a length between first and second ends and, defined by an inner surface having a length between the first and second ends, an internal chamber having a longitudinal centerline. The inner surface includes two or more regions having a first perpendicular distance from the longitudinal centerline separated by two or more regions having a second perpendicular distance from the longitudinal centerline that is different from the first perpendicular distance.

The disclosure also describes a second sleeve for coupling a tool to a tool holder. The second sleeve includes an outer surface having a length between first and second ends and, defined by an inner surface having a length between the first and second ends, an internal chamber having a longitudinal centerline. The outer surface includes two or more regions having a third perpendicular distance from the longitudinal centerline separated by two or more regions having a fourth perpendicular distance from the longitudinal centerline that is different from the third perpendicular distance.

Further, the disclosure describes a third sleeve for coupling a tool to a tool holder. The third sleeve includes an outer surface having a length between first and second ends and, defined by an inner surface having a length between the first and second ends, an internal chamber having a longitudinal centerline. The inner surface includes two or more regions having a first perpendicular distance from the longitudinal centerline separated by two or more regions having a second perpendicular distance from the longitudinal centerline that is different from the first perpendicular distance. The outer surface includes two or more regions having a third perpendicular distance from the longitudinal centerline separated by two or more regions having a fourth perpendicular distance from the longitudinal centerline that is different from the third perpendicular distances.

Further still, the disclosure describes a bushing for coupling a tool to a tool holder. The bushing includes an outer surface having a length between first and second ends and, defined by an inner surface having a length between the first and second ends, an internal chamber having a longitudinal centerline. The inner surface includes two or more contact patches separated by a rotation about the longitudinal centerline.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those of ordinary skill in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a perspective view of an example tool holder sleeve or bushing.

FIG. 2 illustrates a right side view of the example tool holder sleeve or bushing FIG. 1.

FIG. 3 illustrates a front view of the example tool holder sleeve or bushing FIGS. 1 & 2.

FIG. 4 illustrates a rear view of the example tool holder sleeve or bushing FIGS. 1-3.

FIG. 5 illustrates a top view of the example tool holder sleeve or bushing of FIGS. 1-4.

FIG. 6 illustrates a bottom view of the example tool holder sleeve or bushing of FIGS. 1-5.

FIG. 7 schematically illustrates an example transverse cross-section profile suitable for use in association with disclosed sleeves and/or bushings.

FIG. 8 schematically illustrates another example transverse cross-section profile suitable for use in association with disclosed sleeves and/or bushings.

FIG. 9 schematically illustrates an example transverse cross-section profile suitable for use in association with disclosed sleeves and/or bushings.

FIG. 10 schematically illustrates another example transverse cross-section profile suitable for use in association with disclosed sleeves and/or bushings.

FIG. 11 illustrates a cross-sectional view of the example tool holder sleeve or bushing of FIGS. 1-6 along plane A-A of FIG. 5.

FIG. 12 illustrates an exploded view of the example tool holder sleeve or bushing of FIGS. 1-11 in association with an example tool and an example tool holder.

### DETAILED DESCRIPTION

The following detailed description illustrates embodiments of the present disclosure and manners by which they can be implemented. Although the best mode of carrying out the disclosed embodiments has been set forth herein, those of ordinary skill in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Internal workpiece turning involves applying separation and/or chip-making operations to the inside of a workpiece. Tools for these operations are frequently long and narrow with significant overhang from the associated anchoring mechanism which may be a sleeve or bushing. Further, known interfaces utilize round boring bars inserted into sleeves or bushings having round inner and outer diameters such that the components mate along what are theoretically single-line contact patches or, practically, very thin strips. These conditions, in addition to other factors, contribute to instability of the tool resulting in chatter.

Multiplying and/or expanding or up-dimensioning of contact patches between the tool and the sleeve holding it and/or between the sleeve and the tool holder improves stability and decreases chatter by increasing the number of points of contact, expanding their surface area and/or balancing their relative placement around a central point. Embodiments of the disclosure substantially eliminate, or at least partially address, problems in the prior art, enabling increased interface stability between tools, sleeves and tool holders.

Additional aspects, advantages, features and objects of the disclosure will be made apparent from the drawings and the detailed description of the illustrative embodiments construed in conjunction with the appended claims that follow. It will be appreciated that features of the disclosure are susceptible to being combined in various combinations without departing from the scope of the disclosure as defined by the appended claims.

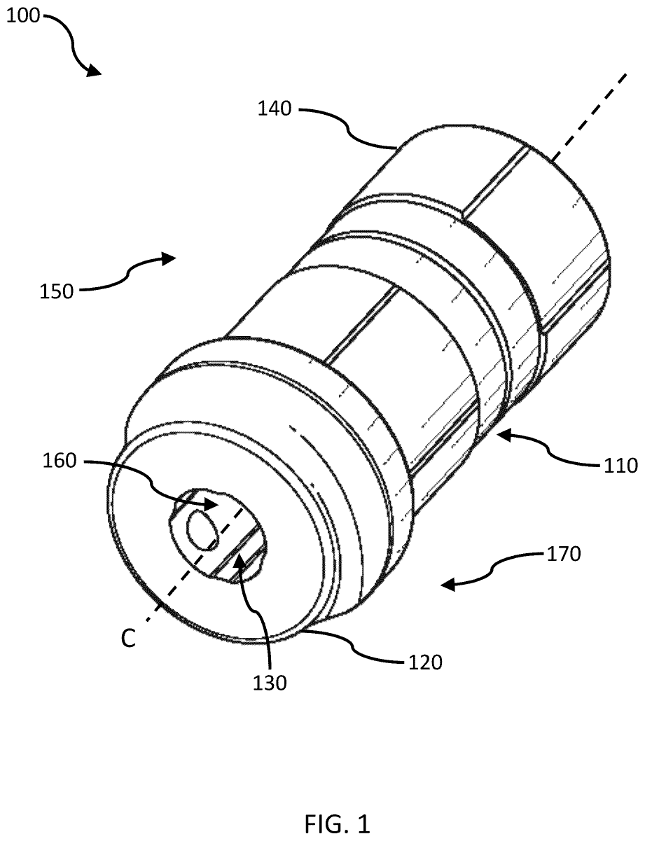

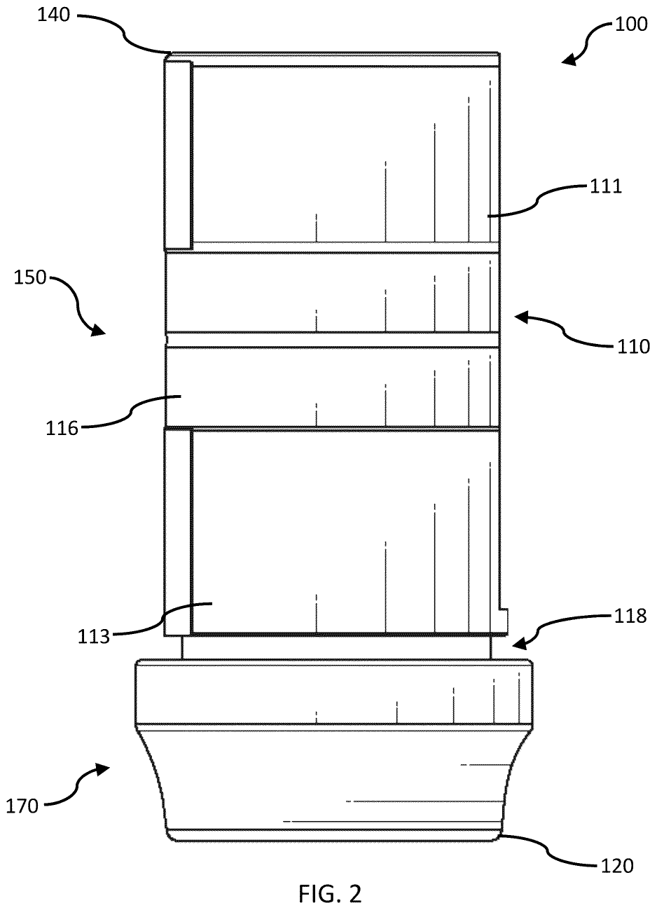

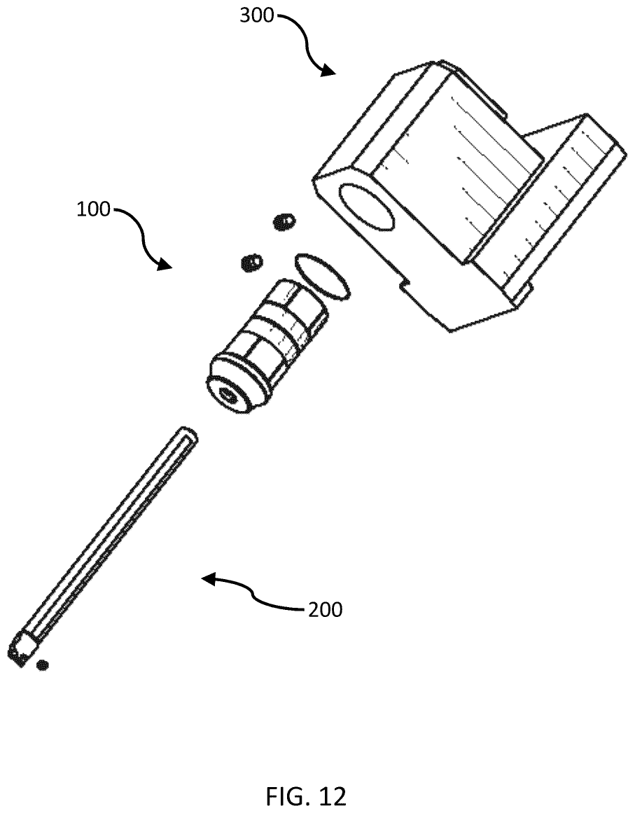

FIGS. 1-11 illustrate an example boring bar bushing or boring bar reduction sleeve 100 which may be suitable for use with a tool such as a boring bar to couple the same to a tool holder of a tool driver (FIG. 12). Sleeve 100 includes an outer surface 110 having a length between first 120 and second 140 ends and, defined by an inner surface 130 having a length between the first and second ends, an internal chamber or lumen 160 having a longitudinal centerline C. Sleeve 100 may include a shank or shaft portion 150 and a head portion 170 which is radially enlarged relative to shaft portion 150. Head portion 170 may exhibit any of a variety of shapes including that of a truncated nozzle or frustum with a through-bore and may have a front face at first end 120.

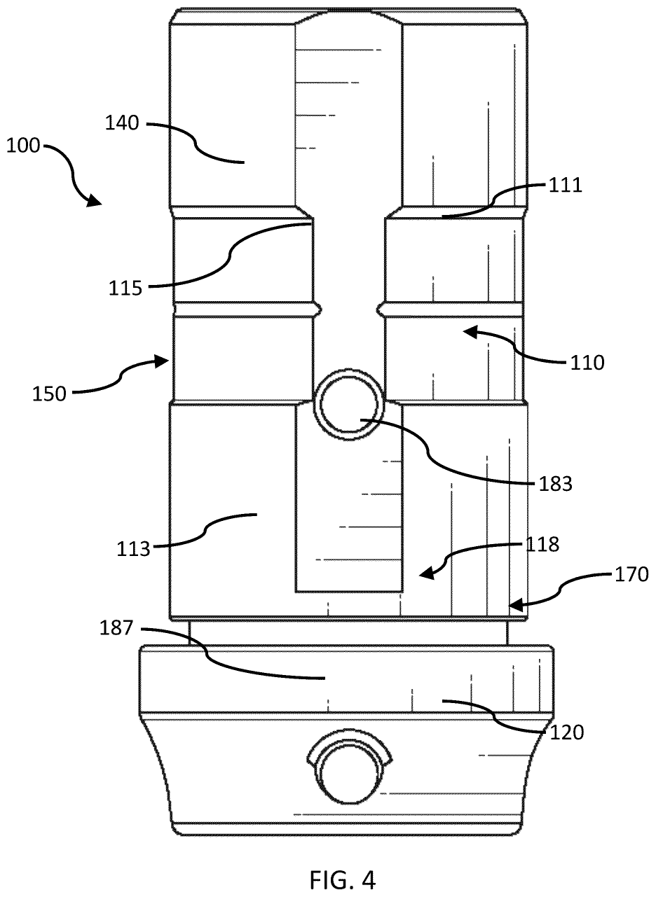

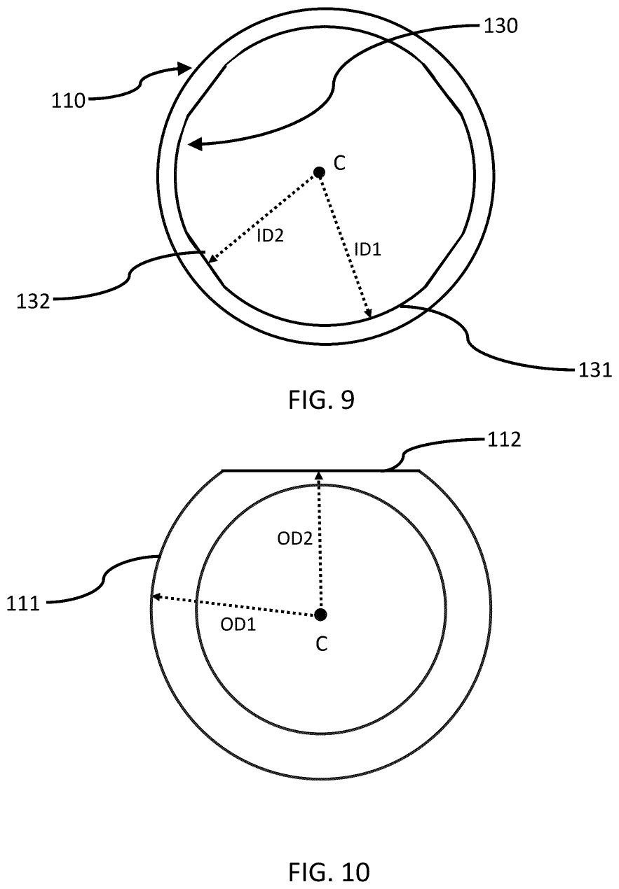

Either or both of head portion 170 and shaft portion 150 may include one or more transverse or approximately transverse set screw holes 161, 163 which may be internally threaded or may be smooth depending on set screw type (FIGS. 4, 9). In a further example, a portion of sleeve 100 surrounding and adjacent to set screw holes 163 may provide a set screw flat 115.

With reference to FIGS. 5-7 & 9, inner surface 130 of example sleeve 100 includes a number of regions 131 having a first perpendicular distance from longitudinal centerline C separated by a number of regions 132 having a second perpendicular distance from the longitudinal centerline that is different from the first perpendicular distance. For ease of reference only, regions 131 may be considered unmodified and regions 132 considered modified. This arrangement of varying distances for inner surface 130 yields a number of internal contact patches separated by rotations about the longitudinal centerline C.

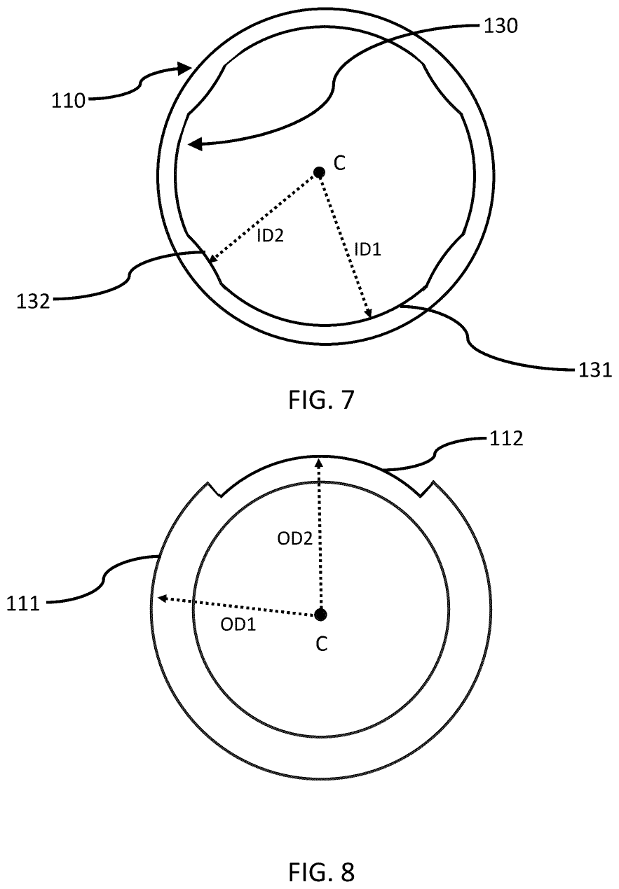

FIG. 7 schematically illustrates an example transverse cross-sectional profile of inner surface 130 which is suitable for use in association with disclosed sleeves and/or bushings. An example inner surface profile is defined at a variable distance from longitudinal centerline C. A first region 131 of the inner surface profile is defined at a first distance ID1 from centreline C while a second region 132 of the inner surface profile is defined at a second distance ID2.

Regions 131 and 132 may take any of a variety of configurations in accordance with the associated perpendicular distances ID1 and ID2 from centerline C and how these distances vary with angle of rotation about the longitudinal centerline. For example, first perpendicular distance ID1 may be fixed. When first perpendicular distance ID1 is fixed, inner surface 113 has a circular profile and/or is generally cylindrical at unmodified regions 131. Second perpendicular distance ID2 may be fixed. As with a fixed first perpendicular distance, when second perpendicular distance ID2 is fixed, inner surface 130 has a circular profile and/or is generally cylindrical at modified regions 132. While the arrangement of a fixed second perpendicular distance ID2 is not illustrated, the results of different fixed perpendicular distances between the two region types will yield inner surface regions effectively having different radii of curvature about longitudinal centerline C.

Second perpendicular distance ID2 may be greater than first perpendicular distance ID1. The effective result is modified regions 132 of removed material. In this arrangement, contact patches for a cylindrical tool or boring bar are at the transition interfaces between modified regions 132 and unmodified regions 131. Alternatively, second perpendicular distance ID2 may be less than first perpendicular distance ID1. The effective result is modified regions of augmented material or regions where material removed from surrounding regions 131 of inner surface 130 has not been removed from modified regions 132. In this arrangement, contact patches for a cylindrical tool or boring bar are within modified regions 132. Referring to FIGS. 5-7, modified regions 132, having a perpendicular distance ID2 less than perpendicular distance ID1, may take the form of lobes wherein the contact patches may be realized as thin, longitudinal strips at or near the apex of the lobes.

Referring to FIG. 9, varying second perpendicular distance ID2 linearly with rotation angle about longitudinal centerline C while holding first perpendicular distance ID1 fixed will yield regions of flat facets alternating or interspersed with regions of semi-circular profile. In this case, the contact patches will be at the interfaces of the unmodified 131 and modified regions 132.

Second perpendicular distance ID2 may vary quadratically with rotation angle about the longitudinal centerline to yield curved regions of inner surface alternating or interspersed with regions of semi-circular profile. A special case of quadratically determined profiles of modified regions 132 of the inner surface may be achieved with a curvature defined by a radius rotated about an axis defined parallel with longitudinal centerline C but outside of outer surface 110 so that modified regions 132 are convex (not shown). In this case, the contact patches will be within modified regions 132.

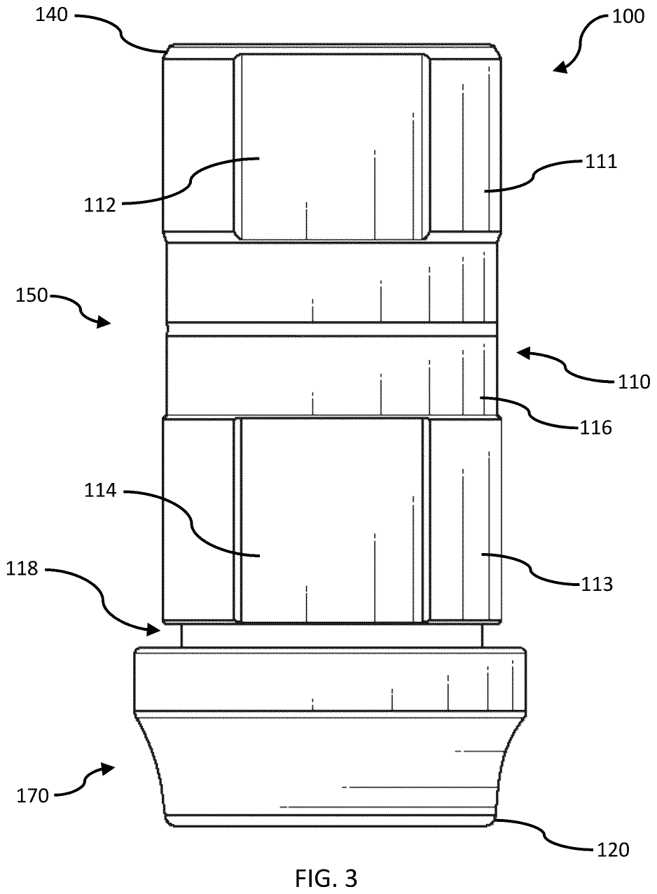

While the varying distance from centerline C of the inner surface 130 of the example shown defines eight regions of profile differentiation, any number of regions suitable for increasing or multiplying interface for a cylindrical tool or boring bar may be provided. In an example, some of the modified regions may be concave while others are convex. While regions 131 defined by ID1 appear to sweep through approximately 70 degrees, these regions may sweep through any angle suitable for increasing contact patches while maintaining structural integrity of sleeve 100. The modified regions 132 of the inner surface 130 each extend along a lengthwise strip having a width defined by a rotation through an arc about the longitudinal centerline. In an example, modified regions 132 of the inner surface sweep through an arc of about 20 degrees. Modified regions 132 of inner surface 130 may extend the entire length of the shaft 150 of sleeve 100 between second end 140 and head 170 either continuously or disjointly (FIGS. 1, 3 & 9) or may only extend over a portion of the length of shaft 150.

With reference to FIGS. 5, 6, 8 & 10, outer surface 110 of example sleeve 100 includes one or more regions 111 having a third perpendicular distance from longitudinal centerline C separated by one or more regions 112 having a fourth perpendicular distance from longitudinal centerline C that is different from the third perpendicular distance. For ease of reference only, regions 111 may be considered unmodified and regions 112 considered modified. This arrangement of varying distances for outer surface yields a number of external contact patches separated by rotations about longitudinal centerline C.

FIG. 8 schematically illustrates an example transverse cross-sectional profile of outer surface 110 which is suitable for use in association with disclosed sleeves and/or bushings. An example outer surface profile is defined at a variable distance from centerline C. A first region 111 of the outer surface profile is defined at a third distance OD1 from centreline C while a second region 112 of the outer surface profile is defined at a fourth distance OD2.

Regions 111 and 112 may take any of a variety of configurations in accordance with the associated perpendicular distances OD1 and OD2 from longitudinal centerline C and how the distances vary with angle of rotation about the longitudinal centerline. For example, third perpendicular distance OD1 may be fixed. When third perpendicular distance ID1 is fixed, outer surface 110 has a circular profile and/or is generally cylindrical at unmodified regions 111. Fourth perpendicular distance OD2 may be fixed. As with a fixed third perpendicular distance, when fourth perpendicular distance OD2 is fixed, outer surface 110 has a circular profile and/or is generally cylindrical at modified regions 112.

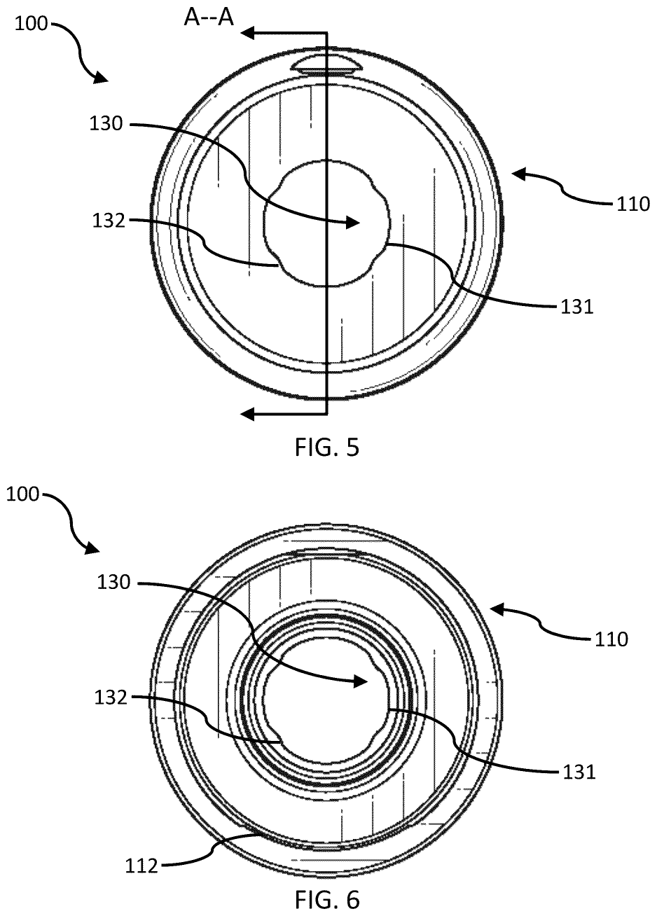

Referring to FIGS. 5, 6 & 8, fourth perpendicular distance OD2 may be less than third perpendicular distance OD1. The effective result is modified regions 112 of removed material. In this arrangement, the contact patches for a cylindrical tool or boring bar are at the transition interfaces between modified regions 112 and unmodified regions 111. Alternatively, fourth perpendicular distance OD2 may be greater than third perpendicular distance OD1. The effective result is modified regions of augmented material or regions where material removed from surrounding regions 111 of outer surface 110 has not been removed from modified regions 112. In this arrangement, the contact patches are within modified regions 112.

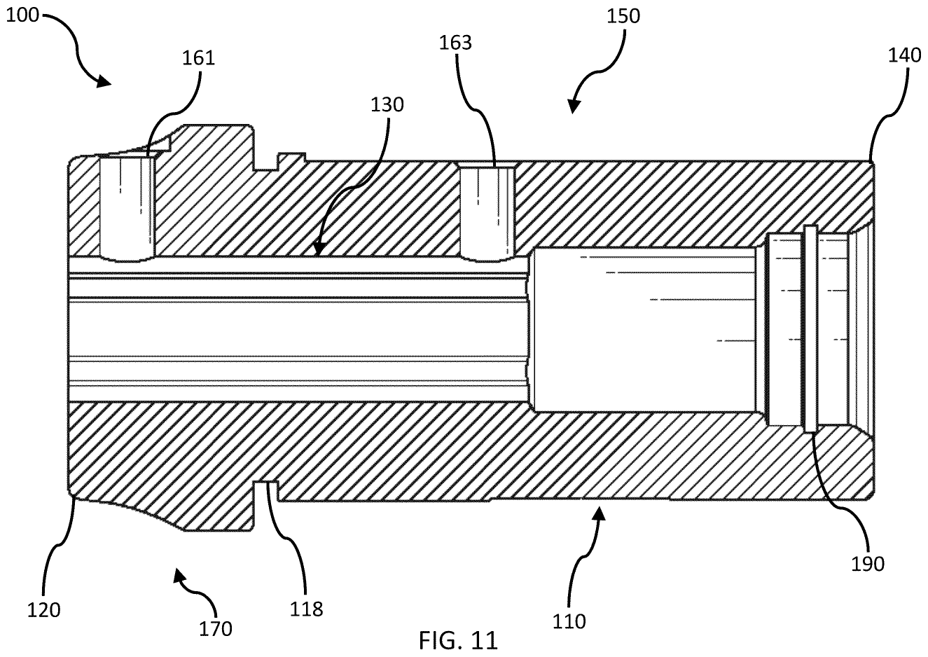

Referring to FIG. 10, varying fourth perpendicular distance OD2 linearly with rotation angle about longitudinal centerline C while holding third perpendicular distance OD1 fixed will yield regions of flat facets alternating or interspersed with regions of semi-circular profile. In this case, the contact patches will be at the interfaces of the unmodified 111 and modified regions 112 and/or 114.

Fourth perpendicular distance OD2 may vary quadratically with rotation angle about longitudinal centerline C to yield curved regions of outer surface alternating or interspersed with regions of semi-circular profile. A special case of the quadratically determined profiles of modified regions 112 and/or 114 of the outer surface 110 may be achieved with a curvature defined by a radius rotated about an axis defined parallel with the longitudinal centerline but outside of the outer surface so that the modified regions are convex. In this case, the contact patches will be within the modified regions 112 and/or 114.

While the varying distance from longitudinal centerline C of the outer surface of the example shown defines two regions of profile differentiation, any number of regions suitable for increasing or multiplying interface contact patches for a cylindrical tool or boring bar may be provided. In an example, some modified regions may be concave while others are convex. While the region 111 defined by OD1 appear to sweep through approximately 270 degrees, the region may sweep through any angle suitable for increasing contact patches while maintaining structural integrity of sleeve 100. Modified regions 12 and 114 of the outer surface each extend along a lengthwise strip having a width defined by a rotation through an arc about the longitudinal centerline. In an example, modified regions 112 and 114 sweep through an arc of about 90 degrees. Modified regions 112 and 114 may extend the entire length of the shaft of the sleeve between the second end 140 and head 170 either continuously or disjointly (FIGS. 1, 3 & 11) or may only extend over a portion of the length of shaft 150.

Referring to FIG. 11, sleeve 100 may further include an interior annular groove 190 formed in inner surface 130 between second end 140 and a midpoint between first end 120 and second end 140. Interior annular groove 190 may be suitably dimensioned and positioned to accommodate a seal produced from injected pliable material to retain lubricant and/or coolant within sleeve 100 during tool driving. Any of a variety of material applicators may be suitable for use with annular groove 190 including but not limited to hot glue guns with mini tips.

FIG. 12 illustrates an exploded view of the example tool holder sleeve of FIGS. 1-7 in association with a tool 200 and a tool holder 300. Sleeve 100 may further include an exterior annular groove 118 formed in outer surface 110 at the interface between head portion 170 and shaft portion 150. Exterior annular groove 118 is arranged to receive an O-ring to seal head portion 170, shaft portion 150 or the interface thereof against receiving or bearing surfaces of a tool holder into which the sleeve is received, for example, when sleeve 100 is received in tool holder 300.

Sleeve 100 may be formed from any of a variety of durable, rigid, workable materials including one or more metals or alloys thereof. In an example, sleeve 100 is formed form high carbon chromium steel such as case hardened 60 HRC. Further, sleeve 100 may take any of a variety of dimensions suitable for use in association with known tools such as boring bars and known tool holders. In an example, sleeve 100 has an overall length of 2.519 inches, a shank length of 2.283 inches, a shank diameter of 1.5 inches, a head diameter of 1.811 inches and a bore diameter of 1.000 inches.

Embodiments of the disclosure are susceptible to being used for various purposes, including, though not limited to, enabling users to improve, enhance, expand, increase in number and/or multiply contact patches between tools and tool sleeves as well as between tool sleeves and tool holders so that stability between these components may be improved and phenomena such as chatter may be reduced.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular may be also to be construed to relate to the plural.

What is claimed is:

1. A sleeve for coupling a tool to a tool holder, comprising:
an outer surface having a length between first and second ends;
defined by an inner surface having a length between the first and second ends, an internal chamber having a longitudinal centerline; and
wherein the inner surface includes two or more regions having a first perpendicular distance from the longitudinal centerline separated by two or more regions having a second perpendicular distance from the longitudinal centerline that is different from the first perpendicular distance.

2. The sleeve as set forth in claim 1, wherein the second perpendicular distance is fixed.

3. The sleeve as set forth in claim 1, wherein the second perpendicular distance is greater than the first perpendicular distance.

4. The sleeve as set forth in claim 1, wherein the second perpendicular distance is less than the first perpendicular distance.

5. The sleeve as set forth in claim 1, wherein the two or more regions of the inner surface each include a curvature defined by a radius rotated about the longitudinal centerline.

6. The sleeve as set forth in claim 1, wherein the two or more regions of the inner surface each include a curvature defined by a radius rotated about an axis defined parallel with the longitudinal centerline and outside of the outer surface.

7. The bushing as set forth in claim 1, further comprising an annular groove formed in the inner surface.

8. A sleeve for coupling a tool to a tool holder, comprising:
an outer surface having a length between first and second ends;
defined by an inner surface having a length between the first and second ends, an internal chamber having a longitudinal centerline; and
wherein the outer surface includes two or more regions having a third perpendicular distance from the longitudinal centerline separated by two or more regions having a fourth perpendicular distance from the longitudinal centerline that is different from the third perpendicular distances.

9. The sleeve as set forth in claim 8, wherein the fourth perpendicular distance is fixed.

10. The sleeve as set forth in claim 8, wherein the fourth perpendicular distance is greater than the third perpendicular distance.

11. The sleeve as set forth in claim 8, wherein the fourth perpendicular distance is less than the third perpendicular distance.

12. The sleeve as set forth in claim 8, wherein the two or more regions of the outer surface each include a curvature defined by a radius rotated about the longitudinal centerline.

13. The sleeve as set forth in claim 8, wherein the two or more regions of the outer surface each include a curvature defined by a radius rotated about an axis defined parallel with the longitudinal centerline and outside of the outer surface.

14. The bushing as set forth in claim 8, further comprising an annular groove formed in the inner surface.

15. A sleeve for coupling a tool to a tool holder, comprising:
an outer surface having a length between first and second ends;
defined by an inner surface having a length between the first and second ends, an internal chamber having a longitudinal centerline;
wherein the inner surface includes two or more regions having a first perpendicular distance from the longitudinal centerline separated by two or more regions having a second perpendicular distance from the longitudinal centerline that is different from the first perpendicular distance; and
wherein the outer surface includes two or more regions having a third perpendicular distance from the longitudinal centerline separated by two or more regions having a fourth perpendicular distance from the longitudinal centerline that is different from the third perpendicular distances.

16. The sleeve as set forth in claim 15, wherein the fourth perpendicular distance from the longitudinal centerline is greater than the first perpendicular distance and the second perpendicular distance.

17. A bushing for coupling a tool to a tool holder, comprising:
an outer surface having a length between first and second ends;
defined by an inner surface having a length between the first and second ends, an internal chamber having a longitudinal centerline; and
wherein the inner surface includes two or more contact patches separated by a rotation about the longitudinal centerline (longitudinal strip of the inner surface).

18. The bushing as set forth in claim 17, wherein the contact patches of the inner surface include regions of removed material.

19. The bushing as set forth in claim 17, wherein the contact patches of the inner surface include regions of augmented material.

20. The bushing as set forth in claim 17, wherein the contact patches of the inner surface are formed by removing material from the inner surface where the contact patches are not.

21. The bushing as set forth in claim 17, wherein the inner surface includes at least three contact patches.
